(19) United States
(12) Patent Application Publication
(10) Pub. No.: US 2015/0170430 A1
(43) Pub. Date: Jun. 18, 2015

(54) Method for Diagnosis and Diagnostic Device for a Motor Vehicle

(71) Applicant: Daimler AG, Stuttgart (DE)

(72) Inventors: Arno Von Querfurt, Schorndorf (DE); Bernd Oeffinger, Fellbach (DE); Siegfried Haefner, Lorch (DE); Thomas Beil, Aichwald (DE); Werner Hillenbrand, Neuffen (DE); Jochen Horwath, Unterensingen (DE); Michael Reiber, Stuttgart (DE)

(21) Appl. No.: 14/404,103

(22) PCT Filed: Jan. 30, 2013
(86) PCT No.: PCT/EP2013/000275

§ 371 Date: Nov. 26, 2014

(30) Foreign Application Priority Data
May 30, 2012 (DE) 10 2012 010 723.4

(51) Int. Cl. G07C 5/00; G07C 5/08

(52) U.S. Cl. CPC G07C 5/008; G07C 5/0808

(57) ABSTRACT

A method for the diagnosis of at least one vehicle component of a motor vehicle involves a) generating a diagnostic script for a diagnostic device of a motor vehicle in a diagnostic script provision unit formed separately from the diagnostic device, b) transferring the diagnostic script by means of a transfer device to the diagnostic device of the motor vehicle, c) authenticating an implementation authorization for the diagnostic script, and d) implementing the diagnostic script in the diagnostic device. Step d) is only implemented in the case of a successful authentication according to step b).

### BACKGROUND AND SUMMARY OF THE INVENTION

Exemplary embodiments of the invention relate to a method for the diagnosis of a component of a motor vehicle, a diagnostic device to implement a diagnostic script, as well as a diagnostic system having such a diagnostic device.

Modern motor vehicles are equipped with a plurality of electronic components. These increase the comfort and security of passengers and at the same time contribute to the reduction in emissions and fuel consumption. However, the risk of the occurrence of malfunctions also thus increases. In order to be able to identify and then repair such errors, more and more powerful electronic methods for diagnosis are used, with which different error states can be detected in vehicle components of the motor vehicle. Known diagnostic devices are often designed to implement so called diagnostic scripts, by means of which the vehicle components having a communication link to the diagnostic device can be analyzed with regard to the occurrence of error states.

In order to be able to implement such a vehicle diagnosis in an effective manner, the diagnostic device can be formed such that the diagnostic scripts that are able to be implemented by it are generated by a suitable external script-generation device and subsequently can be transferred from the script-generating device to the diagnostic device by means of a suitable transfer device. In this way, constantly updated diagnostic scripts can be used in the diagnostic device, which clearly improves the efficiency of the diagnostic device in the implementation of a vehicle diagnosis. After a successful implementation of a diagnostic script, a diagnostic result and/or a diagnostic report can be created in the diagnostic device, which can be made available to a user of the diagnostic device, for example a service employee for the motor vehicle. The diagnostic device also allows the transfer of updates from diagnostic scripts to the diagnostic device. The diagnostic script can be stored in a describable storage unit of the diagnostic device after transmission to the diagnostic device.

German patent document DE 102 13 165 B3 describes a method for the acceptance of program data by a control device in a motor vehicle; this program data is provided by a data transfer point. According to the proposed method, first a program data acceptance query is transmitted to the control device. Subsequently, the program data is transferred to the control device and the program data is accepted by the control device. A security class is allocated to the control device, such that this security class, as well as the current operational state of the control device, is checked in the program data acceptance query. Here, the allocation of the control device to such a security class determines in which operational states of the control device the acceptance of the program data can occur or in which operational states of the control device the acceptance of program data is blocked.

Conventional diagnostic devices, however, have the disadvantage that their implementation can potentially occur in an uncontrolled manner. In particular, the risk of misuse, for example by implementation of diagnostic scripts by a non-authorized user, exists in conventional diagnostic devices.

Accordingly, exemplary embodiments of the present invention are directed to a method for the diagnosis of a component of a motor vehicle, as well as for a device in which the disadvantages named above are eliminated or at least reduced.

The invention is based on the general notion of carrying out authentication for the diagnostic script that is to be implemented before the implementation of a diagnostic script. According to the method according to the invention, a diagnostic script is therefore first generated in a diagnostic script provision device formed separately from the diagnostic device. In order to be able to implement the diagnostic script in the diagnostic device of the motor vehicle, this is transferred from the diagnostic script provision device to the diagnostic device of the motor vehicle by means of a transfer device. An authentication is implemented before the implementation of the diagnostic script. Here, according to the invention, an implementation of the diagnostic script is only carried out by the diagnostic device in the case of a successful authentication. In the case that the authentication is not successful, however, no transfer of the diagnostic script to the diagnostic device is allowed. This prevents non-authorized persons from transferring diagnostic scripts to the diagnostic device.

Therefore, the operational reliability when carrying out the method for diagnosis in the diagnostic device used in a motor vehicle is clearly increased by means of the method according to the invention, as an access restriction or the implementation of diagnostic scripts is implemented by the diagnostic device by means of the method according to the invention.

In a preferred embodiment, the authentication can occur by comparing an entry code, provided by the diagnostic script provision device and transferred from this by means of the transfer device to the diagnostic device, with an authentication code stored in the diagnostic device. In the case that the authentication code stored in the diagnostic device corresponds with the entry code transferred to the diagnostic device, the authentication of the diagnostic device is classified as successful and an implementation of the diagnostic script by the diagnostic device is allowed. This enables a particularly secure authentication.

Preferably, the result of the authentication—successful or not successful—can be stored and documented. Furthermore, a system report can be generated displaying the authentication result on a suitable display in the vehicle or on the diagnostic unit in a service workshop or in the back end of a connected service and maintenance system.

In a particularly preferred, further embodiment, the provision of the entry code can occur by entry of the entry code into an entry unit that has a communication link to the transfer device. This enables external entry of the entry code for the user of the diagnostic device, for example by means of a conventional computer system, in particular in connection with servicing work on the motor vehicle. After successful entry of the entry code, this can be transferred by the transfer device to the diagnostic device and there be compared to the authentication code stored in the diagnostic device, for example in a suitable storage unit. Such a code can, for example, be a conventional PIN code. After successful authentication, according to the invention the diagnostic script generated by the diagnostic script provision device and transferred to the diagnostic device is then implemented.

In further embodiments, the diagnostic script provision device can comprise the entry unit or vice versa. Alternatively, the entry unit and diagnostic script provision device can, however, each also be formed separately. In a simplified embodiment, it is also possible that the diagnostic device itself has a suitable entry unit, by means of which the entry of the entry code, for example by a driver of the vehicle, can occur. In this case, a transfer of the entry code to the diagnostic device is superfluous.

The invention furthermore relates to a diagnostic device for a motor vehicle having an implementation unit formed for the implementation of a diagnostic script. The diagnostic device furthermore has a communication unit, which is connectible to an external diagnostic script provision device by means of a transfer device, such that the diagnostic script can be transferred from the diagnostic script provision device to the implementation device of the diagnostic device. The diagnostic device according to the invention furthermore has an authentication device for the authentication of an implementation authorization for the diagnostic script transferred to the diagnostic device. The authentication device is therein formed in such a way that it allows an implementation of a diagnostic script by the diagnostic device only in the case of a successful authentication. Consequently, the authentication device blocks the implementation of the diagnostic script by the diagnostic device if the authentication, for example due to an entry of an incorrect PIN code, could not be implemented successfully.

In this case, the communication unit of the diagnostic device can be formed in the way of a conventional receiver or transmitter unit, which receives the diagnostic scripts transmitted by the transfer device from the diagnostic script provision device. The communication unit can also function as a transmitter unit, for example in order to be able to transmit a diagnostic result or/and a diagnostic report to a user of the diagnostic device after successful implementation.

In an alternative, simplified embodiment, an authentication according to the invention can also occur in connection with a diagnostic script already transferred to the diagnostic device, i.e. in this case the method steps a) and b) of the provision or transfer of the diagnostic script to the diagnostic device can be dispensed with. In this case, the authentication serves exclusively for the purpose of implementing a diagnostic script already present in the diagnostic device only after successful authentication, for example by a vehicle driver of the motor vehicle.

Furthermore, the invention relates to a diagnostic system for a motor vehicle having a diagnostic device having one or several of the features named above, wherein the diagnostic device can be or is connected to at least one vehicle component of the motor vehicle for the implementation of a vehicle diagnosis by implementation of a diagnostic script. The diagnostic system furthermore comprises a transfer device, by means of which the diagnostic script is transferable to the diagnostic device, as well as a diagnostic script provision device, by means of which the diagnostic script is provided or able to be provided for transfer to the diagnostic device by means of the transfer device.

The diagnostic system can preferably have an entry unit that has a communication link with the transfer device for the entry of the entry code. In this way, the diagnostic device enables a particularly user-friendly entry of the entry code for a user.

In an embodiment that is particularly cost-efficient to produce, the transfer device can comprise a wired or wireless communication link, in particular a mobile radio link.

Further important features and advantages of the invention result from the drawings and the corresponding description of the figures by means of the drawings.

It is understood that the features that are named above and are still to be illustrated below are not only able to be used in the respectively specified combination, but also in other combinations or individually, without exceeding the scope of the present invention.

### BRIEF DESCRIPTION OF THE DRAWING FIGURES

Preferred exemplary embodiments of the invention are depicted in the drawings and illustrated in greater detail in the description below, wherein the same reference numerals refer to the same or similar or functionally identical components.

Herein, schematic views of the following are depicted:

FIG. 1 an exemplary embodiment of a diagnostic device according to the invention,

FIG. 2 an exemplary embodiment of a diagnostic system according to the invention.

### DETAILED DESCRIPTION

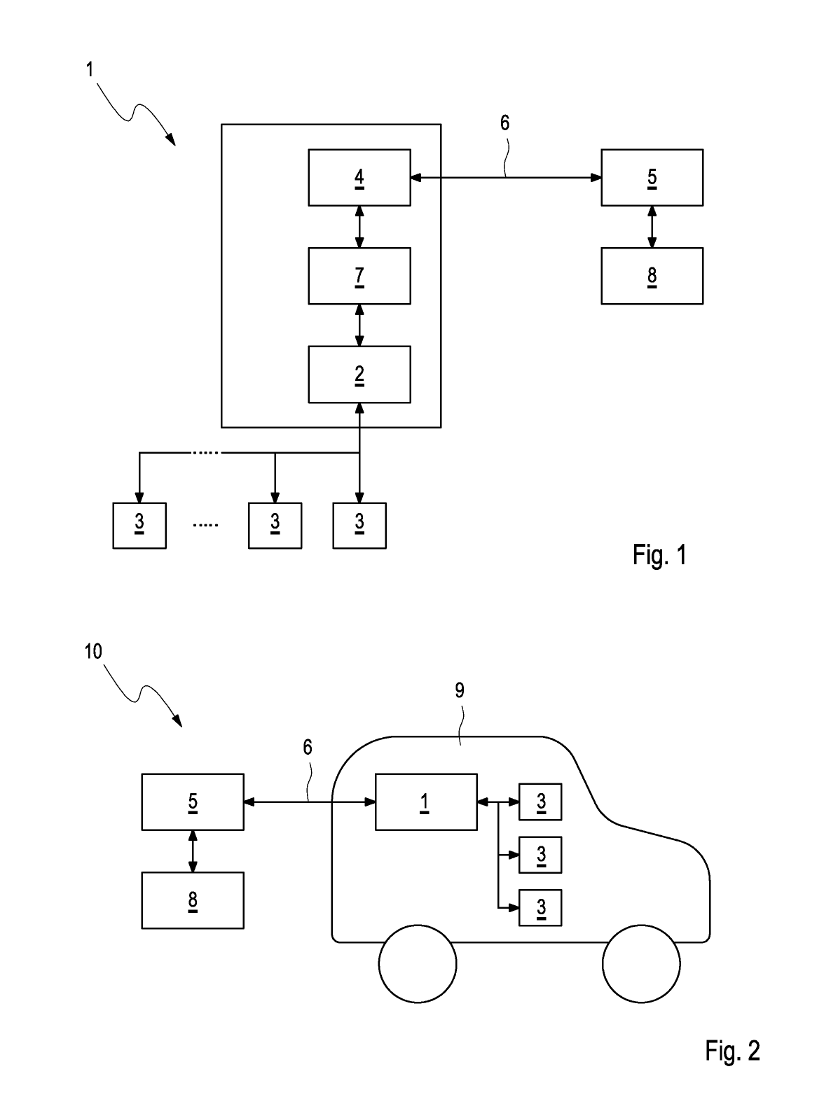

In FIG. 1, a diagnostic device according to the invention for a motor vehicle is depicted roughly schematically and referred to as 1. The diagnostic device can be installed in a motor vehicle and, for example, be part of a conventional control device (ECU) of the motor vehicle.

The diagnostic device 1 has an implementation unit 2, which is formed for the implementation of a diagnostic script. The implementation unit 2 can have a communication link to at least one vehicle component 3, such that by implementation of the diagnostic script in the implementation unit 2, the at least one vehicle component 3 can be analyzed with regard to the occurrence of error states.

The diagnostic script can be stored in a writeable memory in the implementation unit 2. The diagnostic device can also have a communication unit 4 that can be connected to an external diagnosis script provision device 5 by means of a transfer device 6 for the transfer of the diagnostic script from the diagnostic script provision device 5 to the implementation unit 2. The transfer device 6 can be formed to be wireless, for example as a mobile radio device. Correspondingly, the communication unit 4 can have suitable transmitter or receiver. This also applies, in a complementary manner, to the diagnostic script provision device 5.

In one variant, the transfer device 6 can, however, also be formed as a conventional wired transfer device (or in the form of an Ethernet connection, among other things).

The diagnostic device 1 according to the invention has an authentication device 7 for the authentication of an implementation authorization for the diagnostic script transferred to the diagnostic device 1 or to the implementation unit 2 of the diagnostic device 1. The diagnostic device 1 according to the invention in this way enables a reliable implementation of the diagnostic script due to the implementation unit 2 of the diagnostic device 1. By means of the authentication device 7, it can therein be ensured that only authorized persons can initiate the implementation of diagnostic scripts by the diagnostic device 1. An improper implementation of a diagnostic script can in this way be prevented.

For the transfer of a diagnostic script to the diagnostic device 1, a diagnostic script can first be generated in the diagnostic script provision device 5. The diagnostic script provision device 5 can be a conventional computer, in which the desired diagnostic script can be generated by way of a suitable software program.

After completion of such a diagnostic script, this can then be transferred by the diagnostic script provision device 5 using the transfer device 6 to the diagnostic device 1 in the motor vehicle 9. As has already been mentioned, the transfer can occur either wirelessly or via a wired connection. With regard to the practical technical implementation of the transfer device 6, diverse technical implementation possibilities are known for the person skilled in that art. For example, it is possible that an Ethernet connection, among other things, can be provided for diagnostic script transfer between the diagnostic script provision device 5 and the diagnostic device 1. Alternatively, however, as has already been mentioned, a wireless connection via mobile radio or via WLAN is also conceivable. In order to ensure that a non-authorized transfer of diagnostic scripts to the diagnostic device 1 can be eliminated, an authentication of an implementation authorization for the diagnostic script to be transferred is implemented according to the method according to the invention by the authentication device 7 in each case, before this is implemented by the implementation unit 2 of the diagnostic device 1.

Only in the case that the authentication runs successfully does the diagnostic device 1 allow an implementation of the diagnostic script by the implementation unit 2. If, on the other hand, the authentication does not run successfully, an implementation of a new diagnostic script by the implementation unit 2 of the diagnostic device 1 is blocked.

The authentication by the authentication device 7 can therein occur, for example by comparison of an entry code that is transferred from the transfer device 6 to the diagnostic device 1 with an authentication code stored in the diagnostic device 1. The authentication code can therein be stored in the already-mentioned storage unit of the implementation unit 2.

The provision of the entry code can occur by entering the entry code into an entry unit 8 having a communication link with the transfer device 5. Alternatively, the entry unit 8 can be part of the diagnostic script provision unit 5 or vice versa. In the case that the diagnostic script provision unit 5 is a conventional computer, the entry unit 8 can be part of this computer. In a further variant, it is also possible for the diagnostic device 1 itself to have a suitable entry unit, by means of which the entry of the entry code, for example by a driver of the motor vehicle, can occur. In this case, a transfer of the entry code to the diagnostic device 1 is superfluous.

In FIG. 2, a diagnostic system according to the invention for a motor vehicle 9 is now depicted and referred to as 10. The diagnostic system 10 comprises a diagnostic device 1 according to the invention and which is already explained in connection with the depiction of FIG. 1, which has a communication link to at least one vehicle component 3 of the motor vehicle 9 and is installed in the motor vehicle 9. The diagnostic system 10 furthermore comprises the transfer device 6, by means of which the diagnostic script (as described likewise in connection with FIG. 1) is able to be transferred to the diagnostic device 1, as well as a diagnostic script provision device 5, by means of which the diagnostic script can be generated and can be provided for the transfer to the diagnostic device 1. The diagnostic system 1 can optionally have the entry unit 8 for the entry of an entry code, which has a communication link to the diagnostic script provision device 5. The transfer device 6 can comprise a wired or a wireless communication link, in particular a mobile radio link.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-8. (canceled)

9. A method for the diagnosis of at least one vehicle component of a motor vehicle, the method comprising the steps:
a) generating, by a diagnostic script provision unit formed separately from a diagnostic device of a motor vehicle, a diagnostic script for the diagnostic device of the motor vehicle;
b) transferring, via a transfer device, the diagnostic script to the diagnostic device of the motor vehicle;
c) authenticating an implementation authorization for the diagnostic script; and
d) implementing the diagnostic script in the diagnostic device, wherein step d) is only implemented if the authentication according to step b) is successful.

10. The method of claim 9, wherein the authentication involves comparing an entry code, which is provided by the diagnostic script provision device and transferred from the diagnostic script provision device by the transfer device to the diagnostic device, with an authentication code stored in the diagnostic device.

11. The method of claim 10, wherein a result of the comparison authentication, successful or not successful, is retained, documented, or sent back and reported.

12. The method of claim 10, wherein the provision of the entry code involves entering the entry code into an entry unit having a communication link to the transfer device.

13. A diagnostic device for a motor vehicle, comprising:
an implementation unit configured to implement a diagnostic script;
a communication unit connectable to an external diagnosis script provision device by a transfer device for transferring the diagnostic script from the diagnostic script provision device to the implementation unit; and
an authentication device configured to authenticate a transfer authorization for the diagnostic script to be transferred to the diagnostic device.

14. A diagnostic system for a motor vehicle, comprising:
a diagnostic device, comprising
an implementation unit configured to implement a diagnostic script;
a communication unit connectable to an external diagnosis script provision device by a transfer device for transferring the diagnostic script from the diagnostic script provision device to the implementation unit; and
an authentication device configured to authenticate a transfer authorization for the diagnostic script to be transferred to the diagnostic device.
wherein the diagnostic device is connected to at least one vehicle component of the motor vehicle for perform a vehicle diagnosis by the implementation of a diagnostic script.

15. The diagnostic system of claim 14, further comprising:
an entry unit having a communication link to the transfer device for entry of an entry code.

16. The diagnostic system of claim 14, wherein the transfer device comprises a wired or wireless communication link.

17. The diagnostic system of claim 16, wherein the wireless communication link is a mobile radio link.
